(19) United States
(12) Patent Application Publication
(10) Pub. No.: US 2022/0310334 A1
(43) Pub. Date: Sep. 29, 2022

(54) SYSTEM AND METHOD FOR MODIFYING KEYS OF AN ELECTRONIC DEVICE

(71) Applicant: Lenovo (Singapore) Pte. Ltd., New Tech Park (SG)

(72) Inventors: Matthew Manuel Davis, Durham, NC (US); Nathan Hatfield, Raleigh, NC (US)

(21) Appl. No.: 17/215,401

(22) Filed: Mar. 29, 2021

(51) Int. Cl. H01H 13/7065; H01H 13/70; G06F 3/02; G06F 1/16

(52) U.S. Cl. CPC H01H 13/7065; H01H 13/7013; G06F 3/0202; G06F 1/1662

(57) ABSTRACT

An electronic device is provided that includes a display subassembly including a display that visually presents information. The electronic device also includes a base subassembly including plural keys and coupled to the display subassembly, the key having a key characteristic. The electronic device also includes one or more processors, and a data storage device having executable instructions accessible by the one or more processors. Responsive to execution of the instructions, the one or more processors are configured to obtain a user characteristic or an electronic device characteristic, and modify the key characteristic based on the user characteristic or the electronic device characteristic.

### BACKGROUND

Embodiments of the present disclosure generally relate to electronic devices and more particularly to electronic devices with keys that can be modified based on key use and individual use.

A wide variety of electronic devices exist in the marketplace. From personal computers to laptops computers, notebooks, iPads, iPods, personal digital assistants (PDAs), tablets, and the like, such electronic devices are prevalent in society. Each of these electronic devices include input devices that allow a user to place information into the electronic device and operate the device to provide a desired functionality. Such input devices can include touch screens, touch pads, a mouse, a keyboard including individual keys, or the like.

Keyboard keys are fixed for their native device (i.e. notebook, external keyboard, etc.). In particular, each key on the keyboard is provided at a specific location, height, actuation pressure, etc. After receiving a keyboard, there is no variability or customization as it pertains to these types of parameters, and no adjustment for taking ergonomics into consideration.

Keyboards themselves are often used by different users for different purposes. A computing device can be utilized by parents for searching for information on the internet, watching programs, or like. Meanwhile, a teenager may use the same computing device for playing video games. To this end, the teenager may choose to use the computing device for both playing video games and homework. As such, when playing video games the keys used to play the game may undergo extreme and quick repetitive use, compared to a more relaxed actuation pressure when the computing device is used for homework. As such, the repetitive actuation can result in undesired wear of the keys of the keyboard.

Additionally, an individual that is using a device for typing a paper, memo, homework, story, etc. may be typing for long periods of time causing fatigue. With individuals that have medical conditions such as carpal tunnel syndrome, arthritis, or the like, ergonomics is import, and keys on a keyboard are simply insufficient to meet everyone's desired ergonomics.

### SUMMARY

In accordance with embodiments herein, an electronic device is provided that includes a display subassembly including a display that visually presents information. The electronic device also includes a base subassembly including plural keys and coupled to the display subassembly, the key having a key characteristic. The electronic device also includes one or more processors, and a data storage device having executable instructions accessible by the one or more processors. Responsive to execution of the instructions, the one or more processors are configured to obtain a user characteristic or an electronic device characteristic, and modify the key characteristic based on the user characteristic or the electronic device characteristic.

Optionally, obtaining the user characteristic includes obtaining a first user parameter related to the key during a first period of time, and obtaining a second user parameter related to the key during a second period of time after the first period of time. Obtaining the user characteristic also includes comparing the first user parameter to the second user parameter to determine a change in user parameter, and determining if the change in user parameter exceeds a threshold change in the user parameter. In one aspect the first user parameter is a first typing speed, and the second user parameter is a second typing speed. In another aspect, modifying the key characteristic is based on the change in typing speed exceeding the threshold change in the typing speed.

Optionally, obtaining the first user parameter during the first period of time includes determining an average of the first user parameter during the first period of time; and wherein obtaining the second user parameter during the second period of time includes determining an average of the second user parameter during the second period of time. In one aspect, the first user parameter is a first user actuation pressure during the first period of time, and a second user parameter is a second user actuation pressure during the second period of time after the first period of time. In another aspect, the modifying the key characteristic comprises varying key actuation pressure. In one example, the key characteristic includes at least one of key actuation pressure, key height, base subassembly angle to a display subassembly, or key position. In another aspect, the user characteristic includes at least settings of a user, identification of the user, or inputs of the user. In one embodiment, the electronic characteristics include at least one of an application in use, or an input of user.

In accordance with embodiments herein, a method is provided that includes under control of one or more processors including program instructions. The one or more processors are configured to obtain a first user parameter related to a key of an electronic device during a first period of time, and obtain a second user parameter related to the key during a second period of time after the first period of time. The one or more processors are also configured to compare the first user parameter to the second user parameter to determine a change in user parameter, determine if the change in user parameter exceeds a threshold change in the user parameter, and modify a key characteristic based on the threshold change in the user parameter.

Optionally, to modify the key characteristic includes modifying at least one of key actuation pressure, key height, base subassembly angle to a display subassembly, or key position. In one aspect, to obtain the first user parameter includes determining an average of the first user parameter, or determining a median of the first user parameter. In another aspect, the first user parameter includes at least one of user actuation pressure, typing speed, duration of typing, or error rate. In one example, under control of the one or more processors are also configured to obtain a user characteristic related to the key of the electronic device or an electronic device characteristic related to the key of the electronic device, and modify the key characteristic based on the threshold change in the user parameter. In another example, the user characteristic includes at least settings of a user, identification of the user, or inputs of the user. In yet another example, the electronic characteristics include at least one of an application in use, or an input of user.

In accordance with embodiments herein, an electronic device is provided that includes a display subassembly including a display that visually presents information, and a base subassembly including a key and coupled to the display subassembly, the key having a key characteristic. The electronic device also includes one or more processors, and a data storage device having executable instructions accessible by the one or more processors. Responsive to execution of the instructions, the one or more processors are configured to obtain a first user parameter related to a key of an electronic device during a first period of time, obtain a second user parameter related to the key during a second period of time after the first period of time, and compare the first user parameter to the second user parameter to determine a change in user parameter. The one or more processors are also configured to determine if the change in user parameter exceeds a threshold change in the user parameter, and modify a key characteristic based on the threshold change in the user parameter.

Optionally, to modify the key characteristic includes modifying at least one of key actuation pressure, key height, base subassembly angle to a display subassembly, or key position. In one aspect, to obtain the first user parameter includes determining an average of the first user parameter, or determining a median of the first user parameter.

### BRIEF DESCRIPTION OF THE DRAWINGS

FIG. 1 illustrates a perspective view of an electronic device formed in accordance with an embodiment described herein.

FIG. 2 illustrates a side perspective view of an electronic device formed in accordance with an embodiment described herein.

FIG. 3 illustrates a side perspective view of an electronic device formed in accordance with an embodiment described herein.

FIG. 4 illustrates a side perspective view of an electronic device formed in accordance with an embodiment described herein.

FIG. 5 illustrates a side perspective view of an electronic device formed in accordance with an embodiment described herein.

FIG. 6 illustrates a side perspective view of an electronic device formed in accordance with an embodiment described herein.

FIG. 7 illustrates a side perspective view of an electronic device formed in accordance with an embodiment described herein.

FIG. 8 illustrates a schematic block diagram of a control system for an electronic device in accordance with an embodiment described herein.

FIG. 9 illustrates a block flow diagram of a method of modifying a key characteristic of a key of an electronic device in accordance with an embodiment described herein.

FIG. 10 illustrates a block flow diagram of a method of modifying a key characteristic of a key of an electronic device in accordance with an embodiment described herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment,” “in an embodiment” or the like in various places throughout this specification are not necessarily all referring to the same embodiment.

Furthermore, the described features, structures or characteristics may be combined in any suitable manner in one or more embodiments. In the following description, numerous specific details are provided to give a thorough understanding of the various embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The term “base subassembly” refers to any and all assemblies of an electronic device that do not contain a display. The base subassembly may include an input device such as a key of a keyboard, ports such as USB ports, activation buttons, touch pads, or the like. The base subassembly may include a housing for one or more processors, a storage device, functional circuitry, etc.

The term “display subassembly” refers to any and all assemblies of an electronic device that contain a display. The display subassembly may include a screen, touch screen, camera, bevel, etc. The display subassembly may couple to a base subassembly, including via hinge such that the display subassembly and base subassembly can pivot about a pivot axis. The display subassembly may be detachable from the base subassembly. The display subassembly may also not include a base subassembly, such as a tablet, smartphone, or the like. Instead, all input devices, ports, etc. are part of the display subassembly.

The term “user characteristic” refers to any and all traits, parameters, details, information, data, etc. related to a user of a device. User characteristics include characteristics that are input by a user or other, including profile information, user settings, user passwords, application settings, etc. User characteristics also include characteristics obtained by the electronic device, including electronically through communications, and electronically through sensors. Specifically, user characteristics may be obtained through a network, cloud, server, remote device, etc. User characteristics may also be obtained from a disk, thumb drive, hard drive, memory stick, remote device from a wired connection, remote device from a wireless connection, or the like. User characteristics may also be obtained from sensors, including cameras, microphones, motion sensors, fingerprint scanners, biosensors, etc.

The term “electronic device characteristic” refers to any and all parameters, details, information, data, etc. related to an electronic device. The electronic characteristics include electronic device settings, information regarding the electronic device in a storage device of the electronic device, information regarding the electronic device in applications of the electronic device, etc. Electronic characteristics may be obtained electronically through communications, and electronically through sensors. Electronic characteristics can include operation states, application operation states, launching of applications, keyboard use, touch screen use, input device use, the angle between a display subassembly and base subassembly, base subassembly temperature, etc.

The term “obtains” and “obtaining”, as used in connection with data, signals, information and the like, include at least one of i) accessing memory of an external device or remote server where the data, signals, information, etc. are stored, ii) receiving the data, signals, information, etc. over a wireless communications link between the base device and a secondary device, and/or iii) receiving the data, signals, information, etc. at a remote server over a network connection. The obtaining operation, when from the perspective of a base device, may include sensing new signals in real time, and/or accessing memory to read stored data, signals, information, etc. from memory within the base device. The obtaining operation, when from the perspective of a secondary device, includes receiving the data, signals, information, etc. at a transceiver of the secondary device where the data, signals, information, etc. are transmitted from a base device and/or a remote server. The obtaining operation may be from the perspective of a remote server, such as when receiving the data, signals, information, etc. at a network interface from a local external device and/or directly from a base device. The remote server may also obtain the data, signals, information, etc. from local memory and/or from other memory, such as within a cloud storage environment and/or from the memory of a personal computer.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

Electronic devices are provided for automatic and deliberate adjustment of a key, or keys of a keyboard. The electronic device includes a key application that obtains user characteristics and electronic device characteristics, and modifies the keys of the keyboard based on either one or both of the user characteristics or electronic device characteristics. For example, the user characteristics or electronic device characteristics can include one or a combination of typing speed, frequency, application use, or other parameters to adjust the height, actuation pressure, typing angle, key position, etc. to mitigate issues related to prolonged fatigue such as wrist discomfort. To make these determinations, in one example, a machine learning algorithm obtains the user characteristics or electronic device characteristics and makes modifications accordingly.

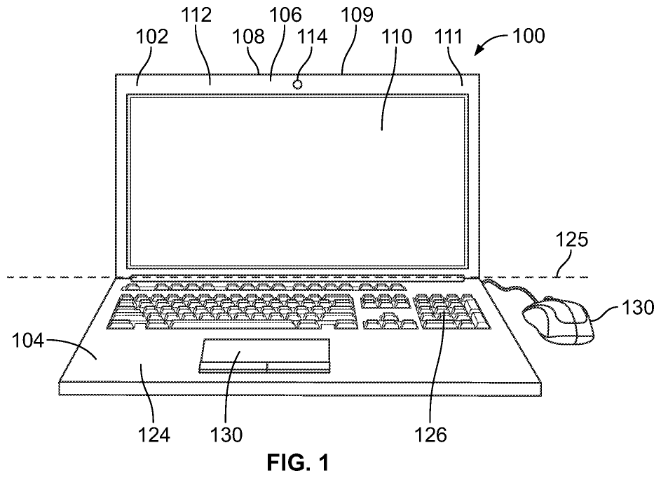

FIGS. 1-7 illustrate views of an electronic apparatus 100 formed in accordance with an embodiment described herein. The electronic apparatus 100 includes a display subassembly 102 and a base subassembly 104 that are coupled with each other. The electronic apparatus in example embodiments is a laptop computer, desktop computer, smart phone, personal digital assistant (PDA), tablet, iPad, iPhone, or the like. The display subassembly 102 in one example is a tablet computer or other electronic device that may be detached from the base subassembly.

The display subassembly includes a housing 106 with an outer shell 108 on a first side 109 and a display 110 on an opposite second side 111. The display 110 may be a touchscreen or non-touch sensitive display. The display 110 visually presents information to a user of the electronic apparatus 100 or the display subassembly 102. In one embodiment, adjacent the display 110 on the first side is a bezel 112 that can include one or more sensors 114 such as a camera, motion detector, infrared camera, microphone, or the like. The sensors 114 may be utilized to obtain user characteristics and/or user parameters that are used by one or more processor to determine an identification of the individual using the electronic device. For example, a camera may be utilized along with photo identification software to identify a person in from the display. In another example, a microphone with voice recognition software can be used to identify the user. The camera and/or microphone can also be utilized to obtain user characteristics that include the number of individuals viewing the display at one time.

Disposed within the housing 106 of the display subassembly 102 are one or more processors, one or more storage devices, a transceiver, battery, circuitry, etc. Specifically, components utilized to operate the electronic device 100 are placed within the housing 106 of the display subassembly.

The base subassembly 104 includes a housing 124 that couples with the housing 106 of the display subassembly 102. In one example, the display subassembly 102 and the base subassembly 104 are rotatably coupled with each other along a pivot axis 125. Rotation about the pivot axis may occur as the result of an elongated hinge, plural hinges, rotational elements, detachable rotational elements, or the like.

The housing 124 receives keys 126 arranged for compression by a user. The keys 126 include numbers, letters, function keys, etc. Each key 126 has key characteristics that provide different ergonomic and wear functionality. Such key characteristics can include key actuation force, key height, a base subassembly angle including the angle between the base subassembly 104 and the display subassembly 102, and the angle between the base subassembly 104 and a surface, key position, or the like.

In one example, the key characteristic can be key actuation force. Specifically, the keys may be on a touch screen, such that any actuation force will result in a key 126 actuating. In another example, when a keyboard is utilized for the purposes of playing a video game on the computer, the actuation force may be significantly increased. In particular, a player may not want a slip of a finger resulting in the incorrect key 126 being actuated during a time when a person is moving their fingers very quickly to accomplish playing the game. In addition, the additional actuation force may also decrease overall wear on the individual keys 126 by resisting the force of the finger of a player. Thus, if a player tends to pound a key 126 with a signification amount of force when getting excited while playing a game, by increasing the resisting force, less wear can occur for the individual key, reducing the likelihood of replacement and increasing life of the key 126 and keyboard. In yet another example, an individual may be using the keyboard for typing an email, paper, memo, or the like. In such an instances, more actuation force for actuation may be desired than when an individual is texting or performing other tasks, but less actuation force than when a game is being played. To this end, when an individual is writing a paper, memo, or the like, when they begin, a first actuation force may be desired, but as a user becomes fatigued, a lesser second actuation force may be desired, and more ergonomic.

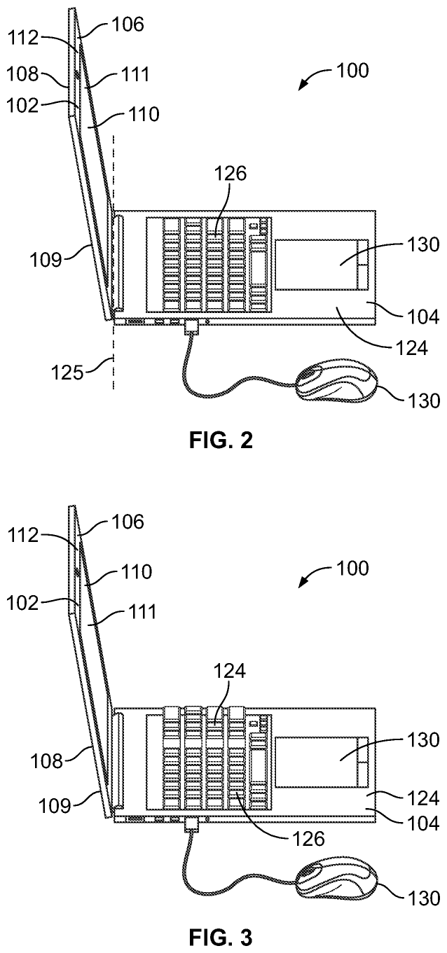

In another embodiment, the key characteristic is the height of the keys. FIGS. 2 and 3 illustrate side views of the keys 126 at a first height (FIG. 2) and a second height (FIG. 3). Similar to key actuation pressure, depending on the use of the keyboard, whether typing a paper, playing a game, merely texting, etc. may present different ergonomic situations for a user. To this end, when a game is being played, more key height may be desired to reduce incorrect pressing of individual keys. Alternatively, when writing a paper, and when a user is fatigued, a shorter key height may be desired. Similarly, when a child in using a keyboard, ergonomically, a shorter key height may be more desirable than when a parent is using the keys 126.

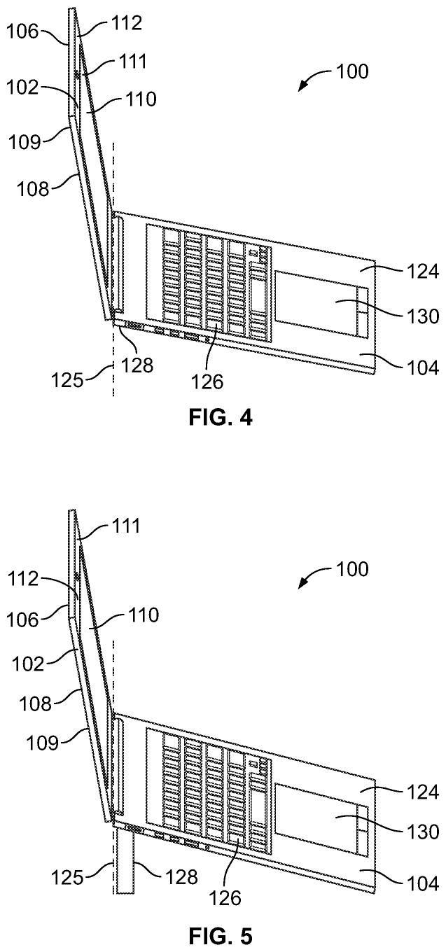

In another embodiment, the key characteristic may be an angle related to a base subassembly 104, such as the angle between the base subassembly 104 and a surface. In one such example, the base subassembly 104 can include adjustable supports 128 extending from a bottom side of the base subassembly 104. Such adjustable supports 128 (FIGS. 4 and 5) may be telescopic, screw based, spring loaded, etc. The adjustable supports 128 can be located only on one side of the base subassembly 104 allowing for pivoting the keyboard to different adjustable angles. The adjustable supports 128 may move the base subassembly 104 from a first angle (FIG. 4) to a second angle (FIG. 5). Additional angles may also be accomplished depending on the functionality of the adjustable supports 128. In particular, different users can have different preferences for typing depending on physical traits, use, etc. The adjustable supports 128 allow adjustment of the angle of the keyboard to accommodate differing preferences. While in one example adjustable supports 128 are provided, in another example, a cover may serve a dual purpose as a cover and as a support. Additional adjustable type supports may also be provided.

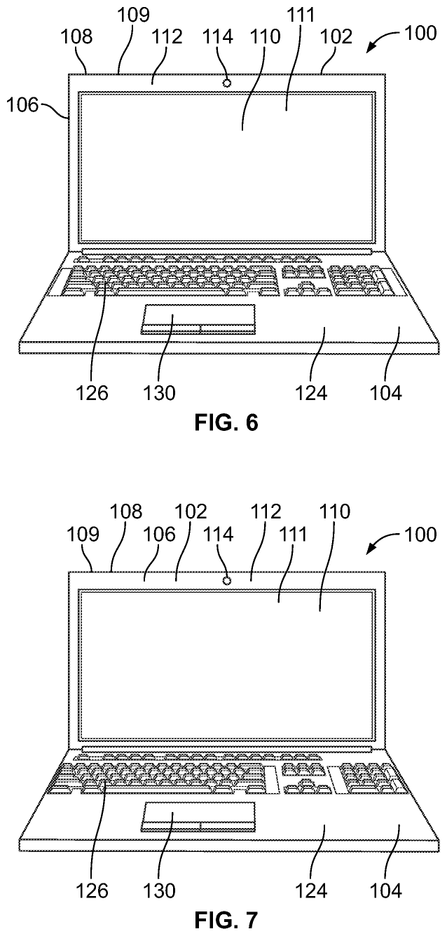

In yet another embodiment, the key characteristic is the spacing between individual keys, or key position. In one example, each key may slidably move from a first position (FIG. 6) to a second position (FIG. 7). In one example, a locking mechanism may be provided to lock the keys 126 in either the first position or second position, preventing sliding of the keys 126 during use. In this manner, individuals with larger hands can provide more spacing between individual keys, causing a more desirable use experience.

In each embodiment, the keys 126 themselves, or base subassembly 104 can be adjusted based on desired ergonomics and use of the keyboard. In this manner, functionality, and ease of use is enhanced, while keyboard life can be increased.

In one embodiment, the base subassembly 104 also includes one or more processors, circuitry, etc. These processors may be similar or identical to the processors in the display subassembly 102. Alternatively, the processors may have more processing capability (e.g., power) relative to the processors. The processors of the display subassembly 102 and/or the processors of the base subassembly 104 may receive signals from the keys 126, input devices 130 such as touch sensitive surfaces, a mouse, or the like, and/or the display 110, and can perform operations based on or use these signals, such as by controlling the information presented on the display 110.

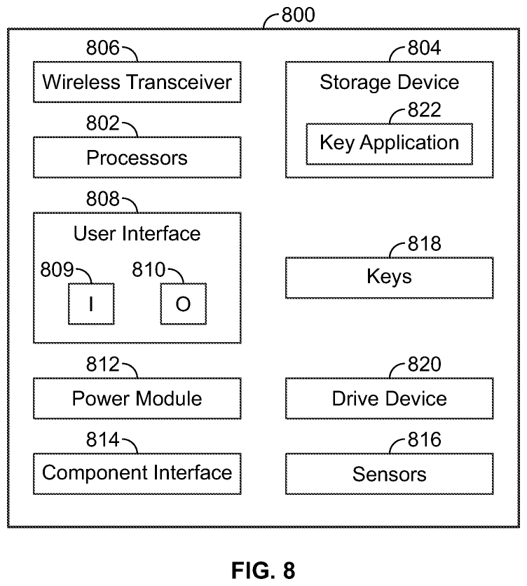

FIG. 8 illustrates a simplified block diagram of a control system 800 for an electronic device. In one example, the electronic device may be any of the electronic devices as described in relation to FIGS. 1-7. To this end, the components of the electronic device may be located only in a display subassembly, only in a base subassembly, or may be located in both the display subassembly and display subassembly.

The control system 800 includes components such as one or more processors 802 (e.g., a microprocessor, microcomputer, application-specific integrated circuit, etc.), one or more local storage medium (also referred to as a memory portion) 804, one or more wireless transceivers 806, a user interface 808 which includes one or more input devices 809 and one or more output devices 810, a power module 812, a component interface 814, one or more sensors 816, a keys 818, and adjustable support drive 820. All of these components can be operatively coupled to one another, and can be in communication with one another, by way of one or more internal communication links, such as an internal bus.

The local storage medium 804 can encompass one or more memory devices of any of a variety of forms (e.g., read only memory, random access memory, static random access memory, dynamic random access memory, etc.) and can be used by the processor 802 to store and retrieve data. The data that is stored by the local storage medium 804 can include, but not be limited to, operating systems, applications, obtained user characteristics, obtained electronic device characteristics, etc. Each operating system includes executable code that controls basic functions of the device, such as interaction among the various components, communication with external devices via the wireless transceivers 806 and/or the component interface 814, and storage and retrieval of applications and context data to and from the local storage medium 806.

The input and output devices 809, 810 may each include a variety of visual, audio, and/or mechanical devices. For example, the input devices 809 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. In one example, the keys 818 function as both input devices 809, and keys 818. The output devices 810 can include a visual output device such as a liquid crystal display screen, one or more light emitting diode indicators, a mechanical output device such as a vibrating mechanism, etc. The display may be touch sensitive to various types of touch and gestures. As further examples, the output device(s) 810 may include a touch sensitive screen, a non-touch sensitive screen, a text-only display, a smart phone display, and/or any combination thereof.

The user interface 808 permits the user to select one or more of a switch, button, or icon to collect user characteristics, and/or electronic device characteristics. The user interface 808 can also direct the one or more sensors 816 to obtain user characteristics. As an example, in one embodiment a sensor is a camera and that can take a photo or video (e.g., capture image data). Alternatively, the sensor can be a microphone, motion sensor, global positioning sensor, or the like. Each sensor provides user characteristics that may be utilized by the one or more processors to determine operation parameters, positioning, etc. of the keys 818. In one example this includes actuation of the adjustable support drive 820. For example, upon detection of motion in front of the display, the one or more processors may automatically determine to extend the adjustable supports for angling the keys 818.

Alternatively, in another example, a determination is made based on the user characteristics of the individual using the electronic device. For example, a sensor that is a camera may include a facial recognition application that can detect that a teenager is using the electronic device 800. The teenager may mainly use the electronic device to play a game where the teenager tends to pound hard on individual keys used for playing. As a result, the one or more processors increase the amount of pressure required to actuate the keys 818. In this manner, the increased pressure prevents mis-actuation of a key due to a slip, effecting the game, while also providing keys 818 more resistance to wear as a result of the extra pressure exerted by the teenager while playing the game. Meanwhile, if a determination is instead made that a parent who does not play games, but instead typically uses a web browser, is using the electronic device, the key actuation pressure of the key may be set to a normal pressure used to type search queries into an internet browser. The one or more processors may make such determination by utilizing an algorithm, mathematical function, mathematical model, lookup table, decision tree, or the like.

In an alternative example, when the teenager is identified, to prepare for game use, the adjustable support drive 820 may be actuated to place a base subassembly flat for playing the game. In yet another alternative embodiment, the key height may be increased. In particular, in one example, the teenager and parent may each have a personal profile related to desired key characteristics. Thus, settings may be provided by both the teenager and parent related to their desired key settings. A parent may have larger hands and desire to have the keys more spread out as compared to a teenager. A parent may also have a hand condition such as arthritis, carpal tunnel syndrome, etc. that may result in the parent desiring to have the lowest amount of key pressure and height possible. Whereas the teenager may desire to prevent mis-strikes of the keys and desire greater pressure, or more height. In another example, the user may want a low-profile “chicklet” style typing experience for work, and then deliberately alter the key parameters for a heightened, more “mechanical” typing experience for play. To this end, key layout profiles can be generated, allowing for users to quickly sort through and select profiles to match their work and play styles (i.e. standing mode, seated mode, writing mode, gaming mode, etc.). In one embodiment, direct manipulation is handled at the individual key level, allowing for both global and local adjustments within a singular profile. For example, when considering modern traversal games, the AWSD keys are used for movement, and the user might prefer these specific keys be heightened while all other keys remain at constant lower height. As such profiles can be made as it pertains to the height, actuation pressure, angle between the display subassembly and base subassembly, key position, etc.

In yet another embodiment, a user can desire the settings of the keys change over time. In one example, when using the keys for game play a first pressure and height may be desired, whereas when using the keys for preparing a paper, a second pressure and height may be desired. To this end, the one or more processors 802 may detect when certain command keys related to playing a game are consistently being actuated. Such user characteristic can be used to place the plural keys 818 in the first pressure and height position versus the second pressure and height position. Similarly, when the actuation of the plural keys in more random, or certain words can be determined, such user characteristics are used to determine the second pressure and height position of the keys 818 is desired.

In yet another example, if an individual is preparing a paper that takes several hours to type, an individual may desire more pressure and height of the keys 818 at the beginning of the preparation of the paper, and less pressure and height at the end of the preparation of the paper. To this end, user characteristics related to the user actuation pressure, duration of typing, typing speed, error rate such as use of certain buttons such as backspace or delete, real time, etc. may all be user characteristics used to determine that an individual is becoming fatigued such the less key actuation pressure, and less key height is desired. In each instance, user characteristics are determined by sensors 816, input profiles, input devices 809, or the like to determine key characteristics such as key actuation pressure, key height, base subassembly angle, key spacing, or the like.

In addition, the sensors 816, input devices 809, etc. may also be utilized to obtain electronic device characteristics. For example, a determination can be made whether the electronic device is opened or closed. In addition, electronic device characteristics can also be determined by the one or more processors. For example, determinations can be made related to applications that are in use by the electronic device. For example, if a word, excel, PowerPoint, or other drafting application is in use, the one or more processors can determine such electronic device characteristics. Based on such electronic device characteristics, the one or more processors may determine that a person is using the plural keys 818 to input information for a paper, memo, graph, data entry, or the like. As a result, a first key actuation pressure, key height, base subassembly angle, etc. can be implemented. Alternatively, the electronic device characteristics may include opening a game application, game website, game browser, or the like such that a determination that a second key actuation pressure, key height, base subassembly angle, etc. can be provided. In yet another example, a user profile manually populated by a user with regard to the specific electronic device 800 may be an electronic device characteristic. As indicated, in each example and embodiment, the one or more processors may make such determinations by utilizing an algorithm, mathematical function, mathematical model, lookup table, decision tree, or the like.

The local storage medium 806 in one embodiment stores various content including, but not limited to a key application 822. The key application 822 includes executable code that utilizes an operating system to provide more specific ergonomic positions based on user characteristics and/or electronic device characteristics. The key application 822 may be accessed by a user on the display such that the user can control whether the keys 818 and adjustable supports are to be in a first position, second position, third position, or otherwise. Similarly key actuation pressure, key height, base subassembly angle, etc. may also be manually input into the one or more processors.

In one example, the user may input user profile inform related to the specific user. In this manner, when the user logs into the electronic device, or alternatively is determined to be using the electronic device, the user may have specific settings for the ergonomics of the keys. For example, a user may choose to have the keys at a maximum key actuation pressure and key height when a game application is in use. In another example, the user may choose to input that when a program such as word, excel, PowerPoint, etc. is in use, that the keys should be placed at a lower position, and with less key actuation pressure. Alternatively, a user may pick and choose which applications cause the desired ergonomics of the keys 818. In this manner, the key application 822 can be used to provide desired parameters of the keys 818 and adjustable support engine 820 for each individual using an electronic device.

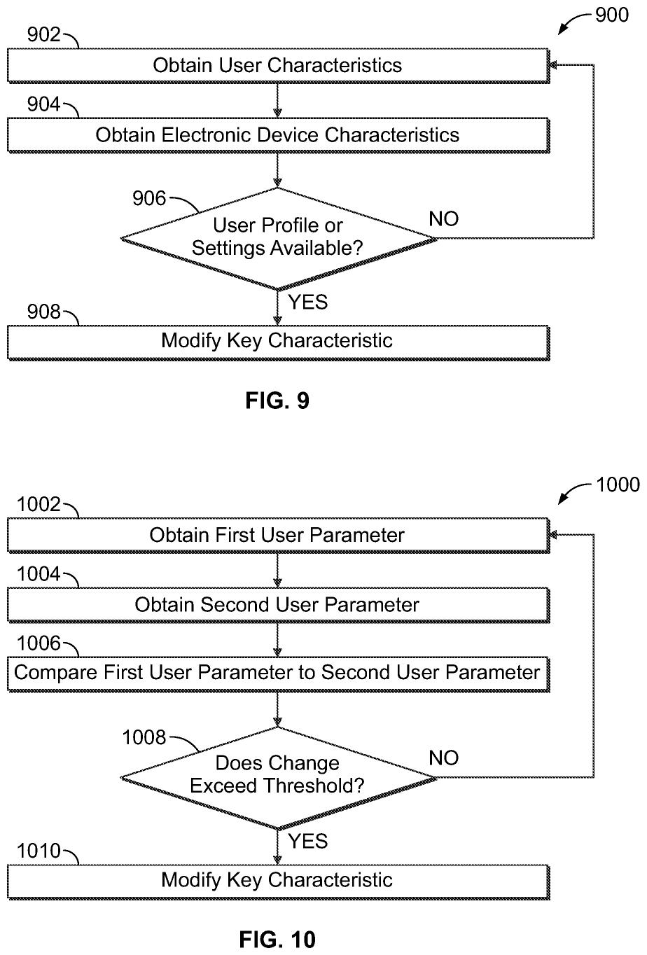

FIG. 9 illustrates a block flow diagram of a method 900 for modifying a key of a base subassembly of an electronic device. In one example, an electronic device of FIGS. 1-7 is utilized to implement the method 900. In another example, the control system of FIG. 8 is used to execute instructions to provide the method 900. The electronic device may include a personal computer, laptop computer, tablet, phone, watch, smart device, iPad, iPod, or the like.

At 902, the one or more processors obtain user characteristics. In one example, the user characteristics are obtained via detecting an individual using the electronic device using a sensor such a camera, microphone, motion detector, or the like. To this end, facial recognition, voice recognition, artificial intelligence (AI) modeling, etc. may be used to obtain the user characteristics. In addition, information input into the electronic device may be used to obtain the user characteristic, including the identity of the individual using the electronic device. Such input information includes login information, passwords, application logins and passwords, permission settings, fingerprint scanning, retinal scanning, user profile, user settings, or the like. In each instance, the user characteristic obtained provides information related to the identity of the individual using the electronic device.

At 904, the one or more processors obtain electronic device characteristics. In one example, the electronic device characteristics include whether the electronic device is in an opened or closed position, the position of a display subassembly compared to a base subassembly, or the like. In other examples, the electronic device characteristics also include the launching, access, or use of applications, the manual input provided by a user, or the like. For example, the accessing or launching of a game application, office application, etc. may be the electronic device characteristic. Alternatively, a user actuating a key input or button can be the electronic device characteristic. Additionally, settings, including key settings of an electronic device can be the electronic device characteristic. To this end, such a setting may be both a user characteristic and electronic device characteristic.

At 906, the one or more processors determines if a user profile and/or settings are available for the individual using the electronic device and/or the application being used. In particular, based on both user characteristics obtained, and electronic device characteristics obtained, determinations are made regarding the identity of the individual using the electronic device along with applications being utilized by the electronic device. Such determinations may be made using a mathematical model, lookup table, decision tree, algorithm, mathematical function, or the like. If at 906, a determination cannot be made of the availability of a user profile or setting information, then the one or more processors continue to obtain user characteristics and electronic device characteristics.

If at 906, the one or more processors determine a user profile and/or settings are available for the individual using the electronic device, at 908 the one or more processors modify a key characteristic based on the user characteristic or the electronic device characteristic. The key characteristic may be a key actuation pressure, key height, key spacing, angle of base subassembly upon which the plural keys are provided, or the like. In each instance, the one or more processors use either user characteristics or electronic device characteristics to determine the key characteristic that is most ergonomic, or increases the life of the individual keys. In one example, a user profile or setting is not utilized, and instead, based on the user characteristic, and/or electronic device characteristic, the one or more processors determine the modification of the key characteristic. For example, if a particular key used for a game application is repeatedly used, or a number of times in a determined period, such as thirty seconds, a determination is made that a game application is being utilized. As a result, a key characteristic such as key height or key actuation pressure is modified to increase life of the key.

FIG. 10 illustrates a method 1000 for modifying a key characteristic based on user fatigue. In one example, an electronic device of FIGS. 1-7 is utilized to implement the method 1000. In another example, the control system of FIG. 8 is used to execute instructions to provide the method 1000. The electronic device may include a personal computer, laptop computer, tablet, phone, watch, smart device, iPad, iPod, or the like.

At 1002, one or more processors obtain a first user parameter during a first period of time. The user parameter is a measurable quantity that may be observed, determined, calculated or the like over the first period of time. Example user parameters include typing speed of a user, typing pressure exerted on one or more keys, typing errors, or the like. The first period of time meanwhile can be thirty second, one minute, five minutes, or more.

For example, the one or more processors may determine the average words per minute an individual is typing over a five minute span. Alternatively, a median words per minute during the five minute span may be determined. In yet another example, the average words per minute is only determined for periods where no pause in typing exists. As an example, a pause may be considered five or more consecutive seconds without actuation of any keys. In this manner, the one or more processors can differentiate between a slowing of an average words per minute rate as a result of fatigue instead of as a result of pauses for thinking, reading a text on another device, interacting with another person, etc. Still, in each instance the first typing speed is obtained.

In another example, the first user parameter may be a first typing pressure exerted on the keys. Specifically, a sensor may be placed below the keys that is engaged by each individual key when compressed. Then over a first time period, such as five minutes, the average user actuation pressure may be determined from the keys. In another example, the user actuation pressure of each compression of each individual key may be averaged. In this manner, if pressure actuation varies based on placement of the key in relation to the fingers of an individual, such variance is addressed. In another example, a median user actuation pressure may similarly be determined. In each instance, the measurement for each of the individual keys is obtained, determined, etc. and is the first user parameter obtained during the first period of time.

In yet another example, the amount of typing errors in a determined period of time is determined. Again, the determined period of time may be five minutes. In one example, the number of times a delete and/or backspace key are utilized during the period of time is counted. In another example, the number of times an arrow key, mouse, touch pad, etc. can be counted. Similarly misspelled words in the period of time can also be determined. In yet other examples mathematical models, functions, calculations, or the like that utilize one or more of these variables can be used to obtain a user parameter.

In yet another example, a sensor may include facial recognition software that can determine the amount of blinking and individual has over a determined period of time. Similarly, head nodding, eyes closing, and other indicators that may suggest an individual is getting sleepy or fatigued may also be utilized. Again, the number of times such activity is detected in a determined period of time may be utilized as a user parameter.

At 1004, the one or more processors obtain a second user parameter during a second period of time after the first period of time. Specifically, the same parameter may be obtained for the first user parameter in the same manner. To this end, any of the examples related to obtaining the first user parameter, or related to the first user parameter itself may be provided to obtain the second user parameter, or may be the second user parameter. The only difference is the period of time in which such user parameter is obtained. The second period of time may be the same length or duration as the first period of time such that comparisons can provide information or determinations related to fatigue associated with a user.

At 1006, the one or more processors compare the first user parameter to the second user parameter to determine a change in the user parameter. In example embodiments, the comparison is made using a lookup table, algorithm, mathematical function, mathematical model, decision tree, or the like. In one example, the first user parameter is simply subtracted from the second user parameter. Therefore, in an example when the first user parameter is a first typing speed, and the first typing speed during a first five minute time period is sixty (60) words per minute, and the second user parameter is a second typing speed during a second five minute time period that is fifty (50) words per minute, the change in the user parameter is ten (10) words per minute. Similarly, other user parameters may be compared to determine the change in the user parameter.

At 1008, a determination is made regarding whether the change in the user parameter exceeds a threshold change in the user parameter. In particular, variances in user parameters over time is expected. As an example, if typing a paper and during a first period of time an unusual number of large words are used, the average words per minute typed will naturally decrease. Consequently, a margin of error is provided as the threshold to account for such variances. In one example, the threshold may be five (5) words per minute. So, in an example when the number of words typed per minute varies by four words a minute, the change in the user parameter does not exceed the threshold change at 1008, and the one or more processors continue obtaining first user parameters and second use parameters. To this end, the second use parameter may become a first user parameter used for comparison against additional user parameters obtained.

If at 1008 the change in user parameter exceeds the threshold, then at 1010, the one or more processors modify a key characteristic based on the change in user parameter exceeding the threshold change. In an example where the threshold is 5 words per minute, and a 10 word per minute change is determined, an indication that fatigue is presented is provided. As such, one or more keys may reduce in height, reduce in key actuation pressure, etc. to make actuating the plural keys simpler for the fatigued individual. In another example, the number of times a certain key is actuated in a period is considered for the first user parameter and second user parameter. When the number of times a particular key is actuated exceeds the threshold, an indication that a game is being played instead of normal typing is provided. As a result, the height of the key and/or key actuation pressure can increase is response to such determination. Consequently, a more ergonomically pleasing experience is provided while increasing key life.

As will be appreciated by one skilled in the art, various aspects may be embodied as a system, method, or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code embodied on a storage medium may be transmitted using any appropriate medium, including but not limited to, wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

Although illustrative example embodiments have been described herein with reference to the accompanying figures, it is to be understood that this description is not limiting and that various other changes and modifications may be affected therein by one skilled in the art without departing from the scope or spirit of the disclosure.

The modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. An electronic device comprising:
a display subassembly including a display that visually presents information,
a base subassembly including a key and coupled to the display subassembly, the key having a key characteristic;
one or more processors;
a data storage device having executable instructions accessible by the one or more processors;
wherein, responsive to execution of the instructions, the one or more processors are configured to:
obtain a user characteristic or an electronic device characteristic; and
modify the key characteristic based on the user characteristic or the electronic device characteristic.

2. The electronic device of claim 1, wherein obtaining the user characteristic comprises:
obtaining a first user parameter related to the key during a first period of time;
obtaining a second user parameter related to the key during a second period of time after the first period of time;
comparing the first user parameter to the second user parameter to determine a change in user parameter;
determining if the change in user parameter exceeds a threshold change in the user parameter.

3. The electronic device of claim 2, wherein the first user parameter is a first typing speed, and the second user parameter is a second typing speed.

4. The electronic device of claim 3, wherein modifying the key characteristic is based on the change in typing speed exceeding the threshold change in the typing speed.

5. The electronic device of claim 2, wherein obtaining the first user parameter during the first period of time includes determining an average of the first user parameter during the first period of time; and wherein obtaining the second user parameter during the second period of time includes determining an average of the second user parameter during the second period of time.

6. The electronic device of claim 2, wherein the first user parameter is a first user actuation pressure during the first period of time, and a second user parameter is a second user actuation pressure during the second period of time after the first period of time.

7. The electronic device of claim 6, wherein modifying the key characteristic comprises varying key actuation pressure.

8. The electronic device of claim 1, wherein the key characteristic includes at least one of key actuation pressure, key height, base subassembly angle to a display subassembly, or key position.

9. The electronic device of claim 1, wherein the user characteristic includes at least settings of a user, identification of the user, or inputs of the user.

10. The electronic device of claim 1, wherein the electronic device characteristics include at least one of an application in use, or an input of user.

11. A method, comprising:
under control of one or more processors including program instructions to:
obtain a first user parameter related to a key of an electronic device during a first period of time;
obtain a second user parameter related to the key during a second period of time after the first period of time;
compare the first user parameter to the second user parameter to determine a change in user parameter;
determine if the change in user parameter exceeds a threshold change in the user parameter; and
modify a key characteristic based on the threshold change in the user parameter.

12. The method of claim 11, wherein to modify the key characteristic includes modifying at least one of key actuation pressure, key height, base subassembly angle to a display subassembly, or key position.

13. The method of claim 11, wherein to obtaining the first user parameter includes determining an average of the first user parameter, or determining a median of the first user parameter.

14. The method of claim 11, wherein the first user parameter includes at least one of user actuation pressure, typing speed, duration of typing, or error rate.

15. The method of claim 11, wherein under control of the one or more processors including program instructions also to:
obtain a user characteristic related to the key of the electronic device or an electronic device characteristic related to the key of the electronic device;
modify the key characteristic based on the threshold change in the user characteristic.

16. The method of claim 15, wherein the user characteristic includes at least settings of a user, identification of the user, or inputs of the user.

17. The electronic device of claim 15, wherein the electronic characteristics include at least one of an application in use, or an input of user.

18. An electronic device comprising:
a display subassembly including a display that visually presents information,
a base subassembly including a key and coupled to the display subassembly, the key having a key characteristic;
one or more processors;
a data storage device having executable instructions accessible by the one or more processors;
wherein, responsive to execution of the instructions, the one or more processors are configured to:
obtain a first user parameter related to a key of an electronic device during a first period of time;
obtain a second user parameter related to the key during a second period of time after the first period of time;
compare the first user parameter to the second user parameter to determine a change in user parameter;
determine if the change in user parameter exceeds a threshold change in the user parameter; and
modify a key characteristic based on the threshold change in the user parameter.

19. The electronic device of claim 18, wherein to modify the key characteristic includes modifying at least one of key actuation pressure, key height, base subassembly angle to a display subassembly, or key position.

20. The electronic device of claim 18, wherein to obtain the first user parameter includes determining an average of the first user parameter, or determining a median of the first user parameter.
